(19) United States
(12) Patent Application Publication
(10) Pub. No.: US 2015/0312154 A1
(43) Pub. Date: Oct. 29, 2015

(54) SYSTEMS AND METHODS COMPRISING ONE OR MORE DATA FEED MECHANISMS FOR IMPROVING DOMAIN NAME SYSTEM TRAFFIC MANAGEMENT

(71) Applicant: NSONE Inc., New York, NY (US)

(72) Inventor: Kristopher Beevers, New York, NY (US)

(21) Appl. No.: 14/693,991

(22) Filed: Apr. 23, 2015

Related U.S. Application Data
(60) Provisional application No. 61/984,310, filed on Apr. 25, 2014.

(51) Int. Cl. H04L 12/801; H04L 29/12

(52) U.S. Cl. CPC H04L 47/16; H04L 61/1511

(57) ABSTRACT

Systems and methods improve Domain Name System (DNS) traffic management and comprise ingesting first input data associated with one or more candidate DNS answers, compiling or manipulating of the first input data into a normalized form to provide normalized data that is usable by at least one dynamic DNS system for computing one or more answers to DNS queries, and transferring the normalized data to at least one globally distributed DNS software actor that is responsible for executing one or more DNS traffic management algorithms using the normalized data as second input data for use, wherein the at least one globally distributed DNS software actor is configured to execute a dynamic DNS decision making process utilizing the normalized data.

### CROSS REFERENCE TO RELATED APPLICATION

This application is a non-provisional application claiming the benefit under 35 U.S.C. 119(e) of U.S. Provisional Patent Application No. 61/984,310, filed on Apr. 25, 2014, which is incorporated herein by reference in its entirety.

### FIELD OF THE DISCLOSURE

The present systems and/or methods relate to managing and/or improving Domain Name System (hereinafter “DNS”) traffic management based on one or more data feed mechanisms. The one or more data feed mechanisms may comprise real-time status, metrics, and/or other data (hereinafter “input data”) associated with and/or related to one or more servers, one or more datacenter facilities, one or more networks, and/or one or more entities that are subjects of one or more DNS traffic routing computer-implemented instructions and/or algorithms. The present systems and methods are adapted and/or configured for ingesting the input data and/or distributing the input data to one or more authoritative DNS servers and/or networks. In an embodiment, the present systems and methods ingest the input data and globally distribute the input data or normalized data to at least one selected from at least one authoritative DNS server and at least one DNS network. The present systems and methods may execute one or more computer-implemented steps which may (i) accept input data from at least one selected from at least one external source and at least one internal source via a programmatic interface, (ii) modify the input data and/or incorporate the input data into a larger aggregated dataset, and/or (iii) deliver at least one selected from the raw or original input data, the modified input data, the normalized data and the aggregated dataset to one or more authoritative DNS servers and/or DNS networks.

### BACKGROUND

The DNS is the core Internet system responsible for mapping domain names, such as, for example, www.example.com, to service related details such as internet protocol (hereinafter “IP”) addresses, email servers, internet-accessible resources and the like. An authoritative DNS server or service is a DNS system with definitive information about specific domain names and/or DNS records. The authoritative DNS server is queried by users or intermediary servers to obtain service details for the domain names for which it is authoritative.

Historically, authoritative DNS servers respond to DNS queries by doing lookups and/or inquiries in a simple, static database mapping domain names and record types to service details. For example, the canonical BIND name server software, produced by the Internet Systems Consortium, uses “zone files” encoding DNS record details for records in a DNS “zone,” such as, for example, domain and/or subdomain.

More recently, some DNS server software, or managed DNS service providers with proprietary software, have added capabilities for computing answers to DNS queries dynamically. Instead of performing a simple lookup in a static database to determine the answer to a query, these software and/or systems may gather a collection of possible answers from a database or other source of input. Based upon configuration details and other inputs, such as, for example, the IP address of the requester or system status details of backend services or servers, the system selects one or more answers dynamically to determine the response to the query. Such software or systems generally provide a small set of predefined approaches for computing dynamic answers to a DNS query based on limited, mostly static inputs.

### SUMMARY OF DISCLOSURE

In embodiments, the present systems and methods improve DNS traffic management. The systems and methods may ingest first input data associated with one or more candidate DNS answers, compile or manipulate the first input data into a normalized form to provide normalized data that is usable by at least one dynamic DNS system for computing one or more answers to DNS queries, and transfer the normalized data to at least one globally distributed DNS software actor that is responsible for executing one or more DNS traffic management algorithms using the normalized data as second input data for use, wherein the at least one globally distributed DNS software actor is configured to execute a dynamic DNS decision making process utilizing the normalized data.

In an embodiment, the systems and methods may make a dynamic DNS decision by utilizing the normalized data as second input data for one or more DNS traffic management algorithms.

In an embodiment, the systems and methods may incorporate the normalized data into a local digital data store by each globally distributed DNS software actor.

In an embodiment, the local digital data store may be selected from the group consisting of at least one databases, at least one memory caches, and at least one local digital data store associated with the globally distributed DNS software actor.

In an embodiment, the first input data may be selected from the group consisting of system status data, at least one real-time performance, one or more usage metrics, and data relating to one or more candidate DNS answers.

In an embodiment, the systems and methods may compute a minimized form of the normalized data before transferring the normalized data to the at least one globally distributed DNS software actor.

In an embodiment, the at least one globally distributed DNS software actor may comprise an authoritative DNS server and a programmatic interface may provide the first input data.

In an embodiment, the programmatic interface comprises an application programming interface.

In embodiments, the systems and methods may comprise a programmatic interface for ingesting one or more key/value pairs into at least one data table at an Hypertext Transfer Protocol (HTTP) endpoint or ingestion interface, wherein the programmatic interface examines data values as the data values are ingested and, depending on a key with which the data values are associated, optionally validating or compiling to transmute the data values into normalized form to provide normalized values for use by at least one traffic management algorithm. The systems and methods may comprise at least one globally distributed DNS software actor, which may comprise a DNS traffic management system, connected to the programmatic interface, wherein a minimized representation of changes to apply to the data table is delivered to the at least one globally distributed DNS software actor via a transmission mechanism in near real-time.

In an embodiment, the transmission mechanism may comprise at least one selected from internet messaging, database replication, a transmission mechanism with low latency to deliver the data table changes in near real-time, and combinations thereof.

In an embodiment, multiple transmission mechanisms disseminate a single change to a data table across a plurality of DNS traffic management systems.

In an embodiment, the DNS traffic management system may examine received messages indicating changes in the data table and, optionally, applies the changes to one or more local copies of the data table, wherein the one or more local copies comprise at least one selected from one or more database copies and one or more in-memory caches.

In an embodiment, the DNS traffic management system may receive and apply data table updates and incorporate new data table key/value pairs in execution of one or more DNS traffic routing algorithms.

In an embodiment, the systems and methods may further comprise at least one selected from one or more user tools/scripts, one or more third party data providers and/or one or more data gathering tools/systems that actively gather metrics or sensory input, then send the metrics or other sensory input to one or more programmatic interfaces or one or more validators/compilers that perform aggregation computations, and store key/value pairings associated with the computations directly in databases representing data tables.

In an embodiment, the programmatic interface may comprise an application programming interface and the at least one globally distributed DNS software actor may comprise at least one an authoritative DNS server.

In embodiments, the systems and methods may comprise a non-transitory computer-readable medium with instructions stored thereon, that when executed by a microprocessor, perform improved Domain Name System (DNS) traffic management. The systems and methods may comprise ingesting first input data associated with one or more candidate DNS answers, compiling or manipulating the first input data into a normalized form to provide normalized data usable by a dynamic DNS system for computing or determining DNS answers to DNS queries, and transferring the normalized data to a plurality of globally distributed DNS software actors responsible for executing one or more traffic management algorithms using the normalized data as second input data.

In an embodiment, the systems and methods may further comprise incorporating or including the normalized data into local digital data stores by each globally distributed DNS software actor, wherein the local digital data stores comprise at least one selected from one or more databases, one or more memory caches and one or more local digital data stores.

In an embodiment, the normalized data may be usable in a dynamic DNS decision making process for purposes of DNS traffic management.

In an embodiment, the first input data may comprise at least one selected from system status data, at least one real-time performance, one or more usage metrics, and data relating to one or more candidate DNS answers.

In an embodiment, the systems and methods may further comprise, optionally, computing or calculating a minimized form of the normalized data for purposes of data transfer.

### BRIEF DESCRIPTION OF THE DRAWINGS

So that the features and advantages of the present disclosure can be understood in detail, a more particular description of the present systems and methods may be had by reference to the embodiments thereof that are illustrated in the appended drawings. It is to be noted, however, that the appended drawings illustrate only some embodiments of the present systems and methods and are therefore not to be considered limiting of its scope, for the systems and methods may admit to other equally effective embodiments.

FIG. 1 illustrates a block diagram of a DNS system for improving DNS traffic management in an embodiment;

FIG. 2 illustrates an architecture within a DNS data record in an embodiment; and

FIG. 3 illustrates a block diagram of a flowchart for a computer-implemented method for improving DNS traffic management in an embodiment.

### DETAILED DESCRIPTION OF THE DISCLOSURE

The present systems and/or methods comprise techniques and/or tools for improving DNS traffic management that allow one or more users to configure one or more application specific approaches for identifying, determining and/or computing dynamic DNS answers. The techniques and/or tools may be in the form of computer-implemented steps and/or software that improves DNS traffic management when executed by the present system and/or methods. In an embodiment, the techniques and/or tools are dynamic DNS software and/or DNS systems that improve DNS traffic management. The present systems and methods may utilize at least one library comprising a plurality of predefined computer-implemented instructions and/or software that are combinable to form a complex sequence of filter instructions.

The techniques and/or tools utilized by the present systems and methods include a DNS decision making architecture for selecting, determining and/or calculating DNS answers in response to a DNS query from one or more DNS resolvers. The decision making architecture may make decisions based on input data and/or normalized data that comprises a plurality of factors, which may include, but is not limited to: one or more configuration details related to the DNS query; one or more requester details, such as, for example, at least one internet protocol (hereinafter “IP”) address; one or more system status details, such as, for example, up/down state, geolocation, network connectivity, or other such details about particular candidate DNS answers; and/or one or more system metrics, such as, for example, a system load, active connections or active requests, or other such metrics about candidate DNS answers. A collection of the input data is fed into the present systems and/or methods which comprise at least one DNS traffic routing algorithm and/or instructions which act upon and/or manipulate the input data to identify, determine and/or calculate at least one potential candidate DNS answer and/or a suitable DNS query response.

For the DNS decision making architecture to perform with sufficient and improved accuracy and responsiveness the input data which the DNS decision making architecture acts upon must accurately reflect one or more up-to-date status, one or more metrics and/or other data associated with and/or related to the one or more candidate DNS answers. In embodiments, the present systems and methods comprise one or more techniques and/or tools that gather and/or ingest, aggregate such input data continuously, and deliver the input data, aggregated data and/or normalized data, in real time, to at least one network of DNS servers for use in identifying, determining and/or computing one or more dynamic DNS answers and/or at least one final DNS answer (hereinafter “final DNS answer”).

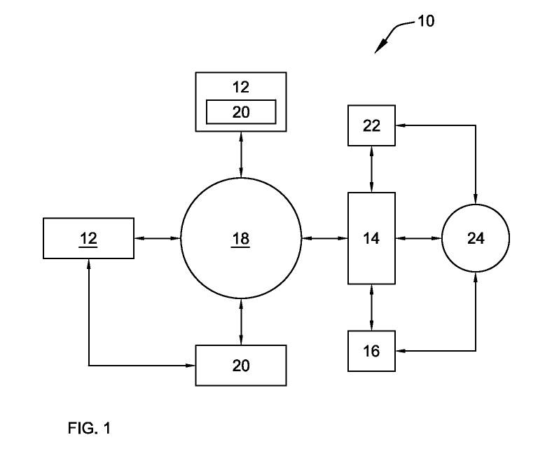

Referring now to the drawings wherein like numerals refer to like parts, FIG. 1 shows a DNS system 10 (hereinafter “system 10”) for improving DNS traffic management, whereby the system 10 comprises at least one client terminal 12 (hereinafter “terminal 12”), at least one authoritative DNS server 14 (hereinafter “DNS server 14”), at least one digital storage device, memory and/or database 16 (hereinafter “database 16”), at least one first digital communication network 18 (hereinafter “first network 18”), at least one DNS resolver 20 (hereinafter “DNS resolver 20”), at least one user interface 22 (hereinafter “interface 22”), at least one second digital communication network 24 (hereinafter “second network 24”) and/or any combination thereof. The DNS server 14 is specifically configured, adapted and/or programmed to make, identify, determine and/or calculate one or more DNS traffic routing decisions and/or to translate one or more domain names into one or more numerical IP addresses.

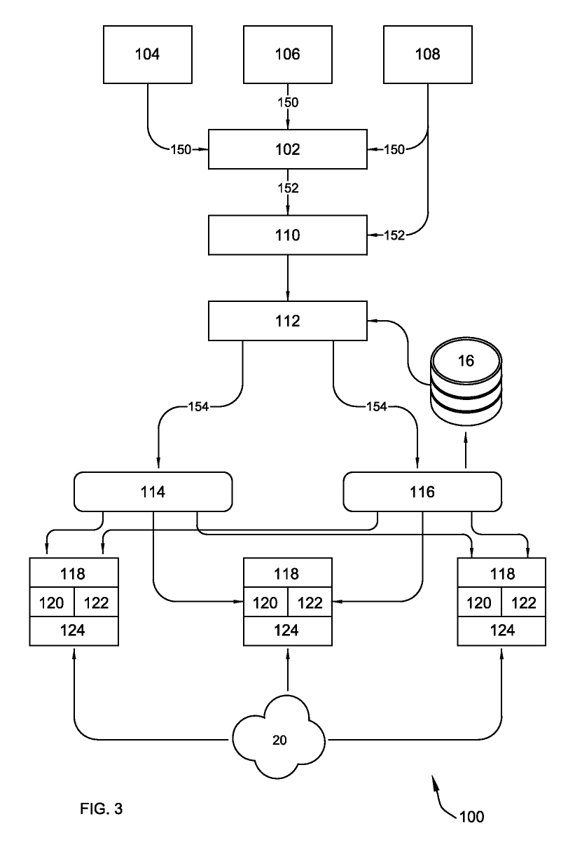

The present disclosure should not be deemed as limited to a specific number of client terminals, DNS servers, databases, communication networks, DNS resolvers and user interfaces which may access and/or may utilize the system 10 and/or the method 100, as shown in FIG. 3, for improving DNS traffic management. The present system 10 and/or method 100 may include and/or incorporate any number of client terminals, DNS servers, databases, communication networks, DNS resolvers and user interfaces as known to one of ordinary skill in the art.

In embodiments, the terminal 12 may be one or more portable digital devices, one or more handheld digital devices, one or more computer terminals or any combination thereof. In embodiments, the terminal 12 may be a wired terminal, a wireless terminal or any combination thereof. For example, the terminal 12 may be wireless electronic media device, such as, for example, a tablet personal computer (hereinafter “PC”), an ultra-mobile PC, a mobile-based pocket PC, an electronic book computer, a laptop computer, a video game console, a digital projector, a digital television, a digital radio, a media player, a portable media device, a PDA, an enterprise digital assistant and/or the like. In other embodiments, the terminal 12 may be, for example, a hyper local digital device, a location-based digital device, a GPS-based digital device, a mobile device (i.e., a 4G mobile device, a 3G mobile device or the like), an ALL-IP electronic device, an information appliance or a personal communicator. The present disclosure should not be deemed as limited to a specific embodiment of the terminal 12.

The terminal 12 may have at least one display for displaying or rendering information and/or multimedia data stored in a memory or at least one digital storage device accessible by a microprocessor (not shown in the drawings) of the terminal 12, streamed to the terminal 12 via the first network 18 or a combination thereof. In an embodiment, the display of the terminal 12 may be a touch-screen graphic user interface (hereinafter “GUI”) or a digitized screen connected to the microprocessor of the terminal 12. The terminal 12 may display or render selected information, data and/or multimedia data to the user associated with the final DNS answer and/or one or more dynamic DNS answers of the DNS query. The selected information, data and/or multimedia data may include one or more web sites, one or more web applications, one or more web pages, digital media, one or more IP addresses, one or more e-mail servers and/or the like that may be accessible via the system 10 and/or method 100.

In embodiments, the terminal 12 may have one or more communication components for connecting to and/or communicating with the first network 18. In an embodiment, the one or more communication components of the terminal 12 may be a wireless transducer, such as, for example, a wireless sensor network device, such as, for example, a Wi-Fi network device, a wireless ZigBee device, an EnOcean device, an ultra-wideband device, a wireless Bluetooth device, a wireless Local Area Network (hereinafter LAN) accessing device, a wireless IrDA device and/or the like.

The terminal 12 may connect to and/or may access the first network 18 via the one or more communication components of the terminal 12. In an embodiment, the terminal 12 may be connected to and/or in digital communication with the DNS resolver 20 via the first network 18. In another embodiment, terminal 12 may be directly connected to and/or in direct digital communication with the DNS resolver 20. In yet another embodiment, the DNS resolver 20 may be integrated into, or part of, the terminal 12. In embodiments, the DNS resolver 20 may be an internet and/or intermediary DNS resolver specifically assigned to the terminal 12 and/or provided by an internet service provider of, or associated with, the terminal 12.

The terminal 12, the DNS server 14 and/or the DNS resolver 20 may be connected to and/or accessible via the first network 18 of the system 10. As a result, the terminal 12 and/or the DNS resolver 20 may be in digital communication with the DNS server 14 and may access at least one internet-accessible resource (hereinafter “internet-accessible resource”) via the first network 18, wherein the internet-accessible resource comprises at least one web site, at least one web page, at least one web application, at least one mobile application, at least one e-mail server, digital information, digital data, digital media content and/or any combination thereof.

In embodiments, the DNS server 14 may be directly connected and/or in direct digital communication with the database 16 and/or the interface 22. In another embodiment, the DNS server 14 may be connected to the database 16 and/or the interface 22 via the second network 24. The database 16 may be a memory or storage medium that is local with respect to the DNS server 14 or may located remotely with respect to the DNS server 14 whereby “remotely” means positioned at a different physical location than the physical location of the DNS server 14. Similar to the database 16, the interface 22 may be located locally or remotely with respect to the DNS server 14. In an embodiment, the system 10 and/or the database 16 may comprise one or more additional DNS systems and/or may be distributed across multiple servers and/or datacenters (not shown in the drawings). In embodiments, the interface 22 and/or one or more components of the system 10 may comprise a programmatic interface 102. In an embodiment, the programmatic interface 102 may be an application programming interface 102.

A memory, digital storage device and/or non-transitory computer-readable medium, which may be accessed and/or executed by a microprocessor incorporated into or included within the system 10 and/or the method 100, may have stored thereon executable ingestion and/or dissemination instructions, one or more ingestion and/or dissemination computer programs, one or more ingestion and/or dissemination algorithms and/or ingestion and/or dissemination software (hereinafter “ingestion and/or dissemination instructions”) that, when executed by the microprocessor, perform the one or more computer-implemented steps of the present method 100 for improving DNS traffic management via the system 10 as shown in FIGS. 1 and/or 3.

In embodiments, the first network 18 and/or the second network 24 (hereinafter collectively known as “networks 18, 24”) may be, for example, a personal area network (PAN), a local area network (LAN), a campus area network (CAN), a Metropolitan area network (MAN), a wide area network (WAN) and/or the like. In an embodiment, the networks 18, 24 may be a wireless network, such as, for example, a wireless MAN, a wireless LAN, a wireless PAN, a Wi-Fi network, a WiMAX network, a global standard network, a personal communication system network, a pager-based service network, a general packet radio service, a universal mobile telephone service network, a radio access network and/or the like. In an embodiment, the networks 18, 24 may be a fixed network, such as, for example, an optical fiber network, an Ethernet, a cabled network, a permanent network, a power line communication network and/or the like. In another embodiment, the networks 18, 24 may be a temporary network, such as, for example, a modem network, a null modem network and/or the like. In yet another embodiment, the networks 18, 24 may be an intranet, extranet or the Internet which may also include the world wide web. The present disclosure should not be limited to a specific embodiment of the networks 18, 24.

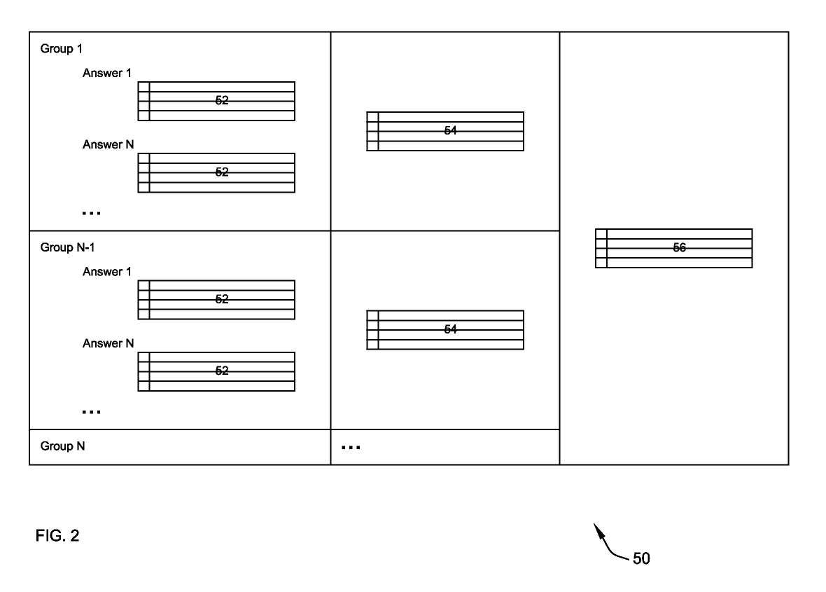

FIG. 2 illustrates a DNS data table 50 for a single DNS record which may have an architecture comprising a plurality of groups wherein each group may comprise a plurality of multiple potential DNS candidates and/or answers. For example, the data table architecture of the single DNS record may comprise Group 1, . . . , Group N−1 and/or Group N, as shown in FIG. 2, which each may further comprise one or more potential DNS answers. In embodiments, Group 1, . . . , Group N−1 and/or Group N may comprise one or more potential DNS answers, such as, for example, potential DNS Answer 1, . . . , potential DNS Answer N−1 (not shown in the drawings), and potential DNS Answer N. Each of the potential or candidate DNS answers may comprise service information typically associated with a DNS answer per applicable RFCs or specifications, such as host name, IP address, and/or other answer specific details, and at least one data table 52 which may be associated with, indicative of and/or related to each of the potential DNS answers of the data table 50. Each group of the data table 50 may comprise one or more group data table, and the data table 50 may comprise at least one record-wide data table. For example, the data table 50 may comprise at least one group data table 54 for each group included within the data table 50, and the data table 50 may comprise at least one record-wide data table 56 as shown in FIG. 2. The number of groups, potential or candidate DNS answers for each group, data tables 52, group data tables 54 and record-wide data tables may be any number of groups, potential or candidate DNS answers for each group, data tables, group data tables and record-wide data tables as known to one of ordinary skill in the art.

In embodiments, the system 10 and/or the method 100 manages and/or improves DNS traffic management by utilizing and/or manipulating one or more data feed mechanisms. The data feed mechanism may be utilized by the system 10 and/or during the method 100 to ingest, compile and/or disseminate one or more metrics and/or other data about one or more potential or candidate DNS answers and/or the final DNS answer for improving DNS traffic management. In embodiments, the data feed mechanism may comprise, or may utilize, one or more data tables, like data table 50 shown in FIG. 2, to improve DNS traffic management. Each of the data tables may be attached or related to, associated with and/or corresponding to one or more routing entities that are subjects of DNS traffic routing systems, such as, for example, one or more DNS servers, one or more groups of one or more DNS servers, one or more DNS traffic routing facilities, one or more DNS networks and/or the like. Such routing entities may represent one or more potential or candidate DNS answers to a DNS query receivable from a DNS resolver, such as, for example, the resolver 20 shown in FIG. 1. The present disclosure should not be deemed as limited to a specific embodiment of the one or more routing entities attached, related, associated and/or corresponding to the one or more data tables.

The attached, related, associated and/or corresponding data tables are uniquely identified, and are represented as pairings of keys (i.e., field names) to values for the data associated with each key for the routing entity. The values may consist of arbitrary data, but all or substantially all values associated with a given key across all data tables follow a consistent format. The data tables may be represented in one or more databases, such as, for example, database 16 of system 10. The name of a key in a data table may be used to indicate which database holds the value associated with the key. For example, data for keys that map to small or simple values, such as, for example, boolean data and/or small strings may be stored in one or more databases of the system 10, such as, for example, database 16. In embodiments, data for keys that map to complex values, such as, for example, large mappings in sub-tables and/or large lists may be stored in one or more alternative databases (not shown in the drawings) and/or in one or more databases of the system 10, such as, for example, the database 16. The architecture of data table 50 in the context of a single DNS record may contain one or more multiple potential or candidate DNS answers in one or more groups which may represent one or more entities or facilities and/or one or more other such groupings of one or more answers as shown in FIG. 2.

In embodiments, the system 10 may comprise and/or the method 100 may utilize the programmatic interface 102, shown in FIG. 3, for feeding one or more new key/value pairs into one or more specific data tables. For example, the programmatic interface 102 may send, or may be utilized to send, at least one new value for at least one given key in at least one given uniquely identified data table to at least one HTTP endpoint and/or one or more similar ingestion interfaces.

In some embodiments, one or more alternative ingestion mechanisms other than the programmatic interface 102 may be used by the system 10 and/or the method 100 for executing and/or performing the data feed mechanism. For example, the system 10 and/or the method 100 may comprise and/or utilize one or more user tools and/or scripts 104 (hereinafter “user tools 104”), one or more third party data providers 106 (hereinafter “third party providers 106”) and/or one or more data gathering tools and/or systems 108 (hereinafter “data gathering tools 108”) as shown in FIG. 3. In embodiments, at least one selected from the user tools 104, the third party providers 106 and the data gathering tools 108 may actively gather metrics or other sensory input, then send the metrics or other sensory input to one or more programmatic interfaces or one or more validators/compilers that may perform aggregation computations, and may store key/value pairings associated with the aggregation computations directly or indirectly in databases of the system 10 representing data tables, such as, for example, the database 16.

The method 100 may comprise and/or utilize at least one selected from the user tools 104, the third party providers 106, the data gathering tools 108, one or more programmatic interfaces, such as, for example, the programmatic interface 102, at least one validator/compiler 110, at least one differential computation 112, at least one database, such as, for example, database 16, at least one messaging network 114, at least one database replication 116, one or more DNS traffic management systems 118 and/or one or more internet/intermediary DNS resolvers, such as, for example, DNS resolver 20, which may be digitally connected and/or in digital communication with one each other or one another via one or more digital communication networks and/or one or more digital communication links, such as, for example, the first network 18 and/or the second network 24. In embodiments, the database 16 may be configured to store one or more data tables, such as, for example, the data table 50, and the DNS traffic management systems 118 may comprise one or more caches 120, one or more databases 122 and/or one or more routing algorithms 124 which may be executable via computer software stored on a non-transitory storage medium that is associated with and/or accessible by the system 10, the method 100 and/or the DNS traffic management systems 118 to make DNS traffic routing decisions.

At least one selected from the programmatic interface 102, the user tools 104, the third party provider 106 and/or data gathering tools 108 are utilized by the system 10 and/or the method 100 for ingesting one or more key/value pairs into one or more data tables, whereby at least one selected from the programmatic interface 102 or data gathering tools 108 may examine the ingested data values or input data values and, depending on the key with which the values are associated, perform validation or compilation, via the at least one validator/compiler 110, to transmute or transform the values into at least one normalized form that suitable and/or capable for use by the one or more routing algorithms 124. As a result, normalized data values are provided which are usable by the one or more routing algorithms 124 to make, determine, identify and/or calculate the final DNS answer to a DNS routing query made by a DNS resolver, such as the DNS resolver 20. In an embodiment, at least one of the user tools 104, the third party provider 106 and/or data gathering tools 108 provide and/or transmit one or more key/value pairs to the programmatic interface 102 via one or more digital communications 150. Moreover, the data gathering tools 108 and/or the programmatic interface 102 may provide and/or transmit one or more key/value pairs to the at least one validator/compiler 110 via one or more digital communications 152.

Following the transmutation or transformation step and/or the compilation step, new or one or more updated key/value pairs in a data table, such as, for example, the data table 50 are compared to one or more existing values in the at least one difference computation 112 to compute at least one minimized representation of the one or more changes to the data in the data table 50.

The minimized representation of one or more changes to apply to the data table 50 may be delivered to a plurality of globally distributed DNS software actors, such as, for example, the one or more DNS traffic management systems 118 via one or more digital transmission mechanisms which may comprise, for example, internet messaging via the at least one digital communication 154, at least one messaging network 114, the at least one database replication 116, other suitable digital transmission mechanism and/or any combination thereof. In embodiments, the one or more digital transmission mechanisms have sufficiently low latency to deliver the data table changes in near real-time or substantially near real-time. Multiple transmission mechanisms may be employed to disseminate a single change to a data table across the one or more DNS traffic management systems 118. It should be understood that the present disclosure is not deemed as limited to a specific embodiment of the one or more digital transmission mechanisms utilized by the system 10 and/or the method 100.

The one or more DNS traffic management 118 systems that receive messages or other types of updates indicating changes in a data table, such as, the data table 50 may examine the updates and, if applicable, apply the one or more changes to local copies of the data table 50, including database copies, or in-memory caches, such as the at least one caches 120.

The one or more DNS traffic management systems 118 receiving and applying data table updates then may incorporate the new data table key/value pairs in execution of the at least one traffic routing algorithms 124. The at least one routing algorithms 124 may examine the data tables, which may include the data table 50, in an execution process and leverage the one or more local copies of the one or more data table keys/values to make efficient and/or improved DNS traffic management decisions. One or more values for one or more specific keys in one or more data tables may be resolved by the at least one routing algorithm 124 according to a hierarchy of the one or more routing entities. For example, one or more values associated with a key in a data table specific to an individual DNS answer, such as, the data table 50 may be preferenced or preferred over a more general value for the same key in a data table associated with a group of such DNS answers, such as, for example, Group 1, Group N−1 and/or Group N as shown in FIG. 2. For example, one or more values associated with a specific key in the data tables 52 of the Answer 1 or Answer N of the Group 1 or the Group N−1 may be preferenced or preferred over one or more values associated with the same key in group data tables 54 and/or the record-wide data table 56 of data table 50.

FIG. 3 illustrates a data table ingestion and dissemination method 100 which may be implemented via the system 10 in an embodiment of the present disclosure. In embodiments, the method 100 may comprise ingesting, feeding and/or providing input data about, related to, corresponding to and/or associated with one or more potential or candidate DNS answers via at least one selected from the programmatic interface 102, the user tools 104, the third party provider 106 and/or the data gathering tools 108. The input data may comprise, but is not limited to, at least one selected from system status data, at least one real-time performance, one or more usage metrics, other data relating to and/or associated with potential or candidate DNS answers and combinations thereof. Further, the method 100 may comprise compiling and/or manipulating the input data into a normalized form and/or data to provide normalized data that is usable by one or more dynamic DNS systems, such as, for example, the DNS traffic management systems 118 in a process for determining, identifying and/or computing DNS answers to DNS queries. In some embodiments, the method 100 may comprise computing a minimized form of the normalized data for purposes of data transfer. In embodiments, the method 100 may comprise transferring the normalized data to a plurality of globally distributed DNS software actors, such as, for example, the DNS traffic management systems 118 which may be responsible for executing at least one routing algorithm 124 using the normalized data as input data. Further, the method may incorporate the normalized data into one or more local digital data stores by each globally distributed DNS software actor, such as, the DNS traffic management systems 118 that received the normalized data. The local digital data stores may comprise, but not limited to, the database 122, the memory caches 120, and/or other local data stores which may be utilized and/or accessed by the dynamic DNS decision making process for purposes of improving DNS traffic management.

In other embodiments, the method 100 may be a computer-implemented method comprising one or more data feed mechanisms for improving DNS traffic management that may be executable by computer software stored on a non-transitory storage medium utilized by the system 10 and/or the method 100. Moreover, a non-transitory computer readable medium with instructions stored thereon may perform the method 100 when the stored instructions are executed by a microprocessor associated with the non-transitory computer readable medium of the system 10.

In embodiments, the method 100 may comprise providing a programmatic interface 102 for feeding, inserting and/or adding one or more new key/value pairs into one or more specific data tables by sending at least one new value for at least one given key in at least one given uniquely identified data table, such as, the data table 50 to a Hypertext Transfer Protocol (hereinafter “HTTP”) endpoint and/or similar ingestion interface. The system 10 and/or method 100 may, optionally, provide tools, such as, the user tools 104, the third party provider 106 and/or data gathering tools 108 which may actively gather one or more metrics or other sensory input, then send the metrics or other sensory input to one or more programmatic interfaces or one or more validators/compilers that perform one or more aggregation computations and/or store one or more key/value pairings associated with the one or more aggregation computations directly in one or more databases representing one or more data tables, such as, for example, the database 16 and/or databases 122 of the DNS traffic management systems 118. The programmatic interface 102 or optional tools for ingesting the one or more key/value pairs into the one or more data tables examine the one or more data values as the one or more data values are ingested and, depending on the key with which the one or more values are associated, may perform validation and/or compilation to transmute or transform the one or more values into normalized form to provide normalized data values that are usable by a traffic management algorithm, such as, for example, the at least one routing algorithm 124. Following the transmutation or transformation and/or compilation, the method 100 may compare one or more new or updated key/value pairs in the data table 50 to one or more existing values in a difference or differential computation to compute a minimized representation of the one or more changes to the data in the data table 50. Further, the method 100 may comprise delivering the minimized representation of the one or more changes to apply to the data table 50 to a plurality of globally distributed DNS software actors, such as, for example, the DNS traffic management systems 118 by a digital transmission mechanism, such as, for example, internet messaging via the messaging network 114, the database replication 116, or another suitable digital transmission mechanism with sufficiently low latency to deliver the data table changes in near real-time or substantially near real-time. In an embodiment, multiple digital transmission mechanisms may be employed to disseminate a single change to a data table, such as, the data table 50 across a plurality of the traffic management systems 118.

In embodiments, the method 100 may comprise examining the updates via the DNS traffic management systems 118 that received one or more messages and/or other types of updates indicating one or more changes in a data table, such as, the data table 50. The method 100 may, optionally, apply the one or more changes to one or more local copies of the data table 50 which may comprise database copies stored in the databases 122 or the in-memory caches 120. Moreover, the method 100 may comprise receiving and applying one or more data table updates via the DNS traffic management systems 118 which may incorporate and/or include the one or more new data table key/value pairs in execution of traffic routing algorithms, such as, the at least one routing algorithms 124.

In other embodiments, the method 100 may comprise ingesting input data associated with one or more potential or candidate DNS answers, wherein the ingested input data comprises at least one selected from system status data, at least one real-time performance, one or more usage metrics, and/or additional data relating to, based on and/or associated with one or more potential or candidate DNS answers. Further, the method 100 may comprise compiling and/or manipulating the input data into a normalized form to provide normalized data that is usable by a dynamic DNS system, such as, for example, the DNS traffic management systems 118 for computing DNS answers to DNS queries. Still further, the method 100 may, optionally, comprise computing and/or calculating a minimized form of the normalized data to provide or produce minimized data for purposes of data transfer. Still further, the method 100 may comprise transferring the normalized data or minimized data to a plurality of globally distributed DNS software actors, such as, for example, the DNS traffic management systems 118 that may executing one or more traffic management algorithms, such as, the at least one routing algorithm 124 using the normalized data or minimized data as input data. Moreover, the method may comprise incorporating and/or including the normalized data or minimized data into one or more local digital data stores associated with and/or accessible by each globally distributed DNS software actor, such as, the DNS traffic management systems 118 which may comprise at least one of the databases 122, the memory caches 120 and/or local digital data stores, wherein the normalized data or minimized data is usable during a dynamic DNS decision making process for improving DNS traffic management.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

1. A computer-implemented method for improving Domain Name System (DNS) traffic management, the method comprising:
ingesting first input data associated with one or more candidate DNS answers;
compiling or manipulating the first input data into a normalized form to provide normalized data that is usable by at least one dynamic DNS system for computing one or more answers to DNS queries; and
transferring the normalized data to at least one globally distributed DNS software actor that is responsible for executing one or more DNS traffic management algorithms using the normalized data as second input data for use, wherein the at least one globally distributed DNS software actor is configured to execute a dynamic DNS decision making process utilizing the normalized data.

2. The method according to claim 1, further comprising:
making a dynamic DNS decision by utilizing the normalized data as second input data for one or more DNS traffic management algorithms.

3. The method according to claim 1, further comprising:
incorporating the normalized data into a local digital data store by each globally distributed DNS software actor.

4. The method according to claim 3, wherein the local digital data store is selected from the group consisting of at least one databases, at least one memory caches, and at least one local digital data store associated with the globally distributed DNS software actor.

5. The method according to claim 1, wherein the first input data is selected from the group consisting of system status data, at least one real-time performance, one or more usage metrics, and data relating to one or more candidate DNS answers.

6. The method according to claim 1, further comprising:
computing a minimized form of the normalized data before transferring the normalized data to the at least one globally distributed DNS software actor.

7. The method according to claim 1, wherein the at least one globally distributed DNS software actor comprises an authoritative DNS server and a programmatic interface provides the first input data.

8. The method according to claim 1, wherein the programmatic interface comprises an application programming interface.

9. A system for improving Domain Name System (DNS) traffic management, the system comprising:
a programmatic interface for ingesting one or more key/value pairs into at least one data table at an Hypertext Transfer Protocol (HTTP) endpoint or ingestion interface, wherein the programmatic interface examines data values as the data values are ingested and, depending on a key with which the data values are associated, optionally validating or compiling to transmute the data values into normalized form to provide normalized values for use by at least one traffic management algorithm; and
at least one globally distributed DNS software actor, comprising a DNS traffic management system, connected to the programmatic interface, wherein a minimized representation of changes to apply to the data table is delivered to the at least one globally distributed DNS software actor via a transmission mechanism in near real-time.

10. The system according to claim 9, wherein the transmission mechanism comprises at least one selected from internet messaging, database replication, a transmission mechanism with low latency to deliver the data table changes in near real-time, and combinations thereof.

11. The system according to claim 9, wherein multiple transmission mechanisms disseminate a single change to a data table across a plurality of DNS traffic management systems.

12. The system according to claim 9, wherein the DNS traffic management system examines received messages indicating changes in the data table and, optionally, applies the changes to one or more local copies of the data table, wherein the one or more local copies comprise at least one selected from one or more database copies and one or more in-memory caches.

13. The system according to claim 9, wherein the DNS traffic management system receives and/or applies data table updates and incorporates new data table key/value pairs in execution of one or more DNS traffic routing algorithms.

14. The system according to claim 9, further comprising:
at least one selected from one or more user tools/scripts, one or more third party data providers and/or one or more data gathering tools/systems that actively gather metrics or sensory input, then send the metrics or other sensory input to one or more programmatic interfaces or one or more validators/compilers that perform aggregation computations, and/or store key/value pairings associated with the computations directly in databases representing data tables.

15. The system according to claim 9, wherein the programmatic interface comprises an application programming interface and the at least one globally distributed DNS software actor comprises at least one authoritative DNS server.

16. A non-transitory computer-readable medium with instructions stored thereon, that when executed by a microprocessor, perform a method for improving Domain Name System (DNS) traffic management, the method comprising:
ingesting first input data associated with one or more candidate DNS answers;
compiling or manipulating the first input data into a normalized form to provide normalized data usable by a dynamic DNS system for computing or determining DNS answers to DNS queries; and
transferring the normalized data to a plurality of globally distributed DNS software actors responsible for executing one or more traffic management algorithms using the normalized data as second input data.

17. The non-transitory computer-readable medium according to claim 16, the method further comprising:
incorporating or including the normalized data into local digital data stores by each globally distributed DNS software actor, wherein the local digital data stores comprise at least one selected from one or more databases, one or more memory caches and one or more local digital data stores.

18. The non-transitory computer-readable medium according to claim 16, wherein the normalized data is usable in a dynamic DNS decision making process for purposes of DNS traffic management.

19. The non-transitory computer-readable medium according to claim 16, wherein the first input data comprises at least one selected from system status data, at least one real-time performance, one or more usage metrics, and data relating to one or more candidate DNS answers.

20. The non-transitory computer-readable medium according to claim 16, wherein the method further comprises, optionally, computing or calculating a minimized form of the normalized data for purposes of data transfer.
